(19) United States
(12) Patent Application Publication
(10) Pub. No.: US 2016/0265959 A1
(43) Pub. Date: Sep. 15, 2016

(54) APPARATUS FOR DETERMINING OR MONITORING THE FILL LEVEL OF A MEDIUM IN A CONTAINER

(71) Applicant: ENDRESS+HAUSER GMBH+CO. KG, Maulburg (DE)

(72) Inventors: Thomas Blodt, Basel (CH); Peter Klofer, Steinen (DE)

(21) Appl. No.: 15/032,194

(22) PCT Filed: Aug. 28, 2014
(86) PCT No.: PCT/EP2014/068206

§ 371 Date: Apr. 26, 2016

(30) Foreign Application Priority Data
Oct. 31, 2013 (DE) 102013112025.3

(51) Int. Cl. G01F 23/284

(52) U.S. Cl. CPC G01F 23/284

(57) ABSTRACT

An apparatus for determining or monitoring the fill level or a predetermined limit level of a medium in a container, comprising a self excited system comprising an oscillation producing unit for producing electromagnetic waves within a predetermined frequency band; at least one sensor having an electrode, wherein the sensor is arranged at a predetermined angle to the longitudinal axis of the container, wherein the electrode is supplied with the electromagnetic waves, wherein the at least one sensor is arranged relative to the medium in such a manner that the phase of the electromagnetic waves reflected at the interface of the medium changes under the influence of the medium; and a feedback loop, which feeds the electromagnetic waves back to the at least one sensor, whereby the frequency of the self excited system is determined, a frequency detector, which registers the frequency of the electromagnetic waves, and an evaluation unit, which based on the registered frequency ascertains the relative dielectric constant and/or the permeability of the medium dependent on the respective fill level and based on the ascertained relative dielectric constant or the permeability of the medium determines the fill level or the reaching of the predetermined limit level of the medium in the container.

The invention relates to an apparatus for determining or monitoring the fill level or a predetermined limit level of a medium in a container.

The applicant manufactures and sells a large number of fill-level measuring devices for industrial automation.

Various measuring principles are applied for determining the fill level of a medium in a container. For example, ultrasonic or radar measuring devices determine the fill level of a fill substance in a container via the travel time of ultrasonic or microwave signals. In the case of these so-called travel time methods, the physical law is utilized that the travel distance equals the product of travel time and propagation velocity of the waves. In the case of fill level measurement, the travel distance corresponds to twice the separation between antenna and surface of the fill substance. The fill level can then be determined from the difference between the known separation of the antenna from the floor of the container and the separation of the surface of the fill substance from the antenna as determined by the measuring.

The disadvantage of radar fill-level measuring devices becomes evident when they are applied in small containers, especially smaller than 1 m. The positional resolution, thus the accuracy of measurement, is then relatively small and the block distance large. The terminology, block distance, means, in such case, the minimum distance from the antenna, after which—taking into consideration the radiation characteristic of the antenna—a reliable measurement is first possible. The influence of block distance can be partially compensated by suitable signal conditioning, e.g. by using a reproducibly guided wave propagation. Corresponding fill level measuring devices are TDR (Time Domain Reflectometry) devices.

Laser measuring devices can also be applied for measuring small distances, but their implementation is costly.

Also applied for continuous fill level measurement are capacitive measuring probes and hydrostatic pressure probes. In the case of capacitive measuring probes, deposits on the probes can reduce the accuracy of measurement. Hydrostatic pressure probes are relatively strongly influenced by pressure changes, which occur especially in the case of filling small containers. Furthermore, indirect methods exist for determining a fill level. Mentionable in this connection is, for example, a drop counter, which is placed on an infusion bag.

A cost effective system for fill level measurement is composed of a plurality of mutually interconnected limit switches, which are responsible for respective, defined height ranges of the container. If a fixed number of limit switches is distributed over the height of the container, then the measurement inaccuracy is greater, the larger the container. In the case of application of 11 limit switches, can the system resolves in steps of 10%. Additionally, multiple limit-level measuring points can be expensive, depending on measuring method; also they can, depending on principle, influence one another.

An object of the invention is to provide an apparatus for determining fill level or limit level of a medium in a container, especially a small container.

The object is achieved by an apparatus for determining or monitoring fill level or a predetermined limit level of a medium in a container, comprising
a self excited system composed of
an oscillation producing unit for producing electromagnetic waves within a predetermined frequency band,
at least one sensor having an electrode, wherein the sensor is arranged at a predetermined angle to the longitudinal axis of the container, wherein the electrode is supplied with the electromagnetic waves, wherein the at least one sensor is arranged relative to the medium in such a manner that the phase of the electromagnetic waves reflected at the interface of the medium changes under the influence of the medium, and
a feedback loop, which feeds the electromagnetic waves back to the at least one sensor, whereby the frequency of the self excited system is determined,
a frequency detector, which registers the frequency of the electromagnetic waves, and
an evaluation unit, which based on the registered frequency ascertains the relative dielectric constant (DKₘₑₐₛ) or the permeability of the medium and based on the ascertained relative dielectric constant (DKₘₑₐₛ) and/or the permeability of the medium determines the fill level or the reaching of the predetermined limit level of the medium in the container.

The index of refraction is the ratio of the speed of light of electromagnetic waves in vacuum to the propagation velocity in the medium. The complex index of refraction is related to the permittivity and the permeability. In such case, the permittivity is a measure for the permeability of a material for electrical fields and permeability is a measure for the permeability of a material for magnetic fields. Permittivity and dielectric conductivity are synonymous terms. The relative permittivity, which is also referred to as permittivity, respectively as the dielectric constant, describes the permittivity of a medium relative to the permittivity of vacuum. Magnetic materials are classified via the permeability as diamagnetic, paramagnetic or ferromagnetic materials.

Although in the following reference is made almost exclusively to the measuring of the relative dielectric constant, the apparatus of the invention can analogously be utilized, in order, in the case of corresponding media, to detect fill level via a permeability measurement.

Preferably, the sensor is composed of an electrode, which is arranged on an insulating material; electrode and insulating material form a measuring cell.

An advantageous embodiment of the solution of the invention provides that the sensor or the measuring cell is arranged on the inner wall of the container, on the outer wall of the container or in the medium. Likewise, the sensor, respectively the measuring cell, can be an integral component of the container wall. Since microwaves penetrate e.g. a plastic pouch, the sensor, respectively the measuring cell, can be adhered on the outer wall of a container made of plastic. Of course, the apparatus of the invention is so embodied that it extends either over the entire fill level of the container, or it is short and covers only a portion of the maximum fill level, e.g. 0%-50% or 60% . . . 100%. Moreover, the apparatus of the invention can also be applied as a limit switch.

The apparatus of the invention can also be referred to as a microwave resonator. As a function of the conditions reigning at the interface with the medium, the apparatus of the invention is able to provide information concerning electrical or magnetic properties, respectively changing electrical or magnetic, properties, of the medium.

The self excited system oscillates in the steady state at a defined oscillation frequency, which lies in the microwave region. The oscillation frequency of the self excited system, e.g of the microwave resonator, depends on the index of refraction at the interface with the medium, wherein the microwave resonator must be so arranged relative to the interface that the oscillation frequency is influenced by the properties of the medium. Thus, the microwave resonator must be arranged in the immediate vicinity of the medium or in the medium. In such case, the thickness of the wall can be greater, when the medium has a high dielectric constant. Measured in connection with the invention is the oscillation frequency, respectively the frequency change, as a result of the influence of the medium. For this, preferably a frequency counter is applied as frequency detector.

An advantageous embodiment of the apparatus of the invention provides that the frequency band, in which the self excited system is oscillatable, lies outside the eigenfrequency of the sensor. The eigenfrequency of the sensor is determined by the geometric dimensions of the sensor, respectively the travel time of the electromagnetic waves reflected within the sensor. As a result thereof, the self excited system has a low quality factor; this is very advantageous for the self excited system. Moreover, a frequency deviating from the eigenfrequency prevents that the sensor acts as an antenna and receives or radiates large energy fractions. Thus, disturbances are reduced. Preferably applied in the apparatus of the invention are the following operating, respectively oscillation, frequencies: 2.4 GHz, 433 MHz, 866 MHz or 5.8 GHz. Quite generally, at least every frequency in the frequency range between 300 MHz and at least 30 GHz can be applied.

The apparatus of the invention can preferably, however, not exclusively, be used for determining fill level in small containers. The terminology, small containers, means especially containers with a longitudinal extension of less, or significantly less, than 1 m. The determining of a small fill level is of great importance in many fields of application. Important fields of application are medical technology and the pharmaceuticals industry. In the pharmaceuticals industry, there is increasingly the trend that the manufacture of medicines occurs via biotech methods in small batches. Since the solution of the invention can be implemented very cost effectively, it is also preferably applicable in single use containments, especially single use bags, such as infusion bags, waste bags or process containers. Through disposal of the containment after one use, sterilizing for additional use can be avoided. Since the apparatus of the invention, respectively the measuring cell or the sensor—such as already mentioned—can also without problem be mounted, e.g. adhered, externally on the containment, also repeated use on different containments becomes possible. Also, recycling is easily implementable.

Other applications are for chemical processes, in which a product is made from a raw or starting material by the application of chemical, physical or biological procedures, and for the foods industry. Known from DE 10 2012 104 075 A1 of May 9, 2012, is a sensor, which is so sensitive that it can be applied in connection with the invention. The corresponding disclosure of DE 10 2012 104 075 A1 (not pre-published) is to be added to the disclosure of the present invention.

An advantageous embodiment of the apparatus of the invention provides that the evaluation unit calculates the fill level absolutely or relative to the maximum height of the fill level of the container according to the following formulas:

h=[DKₘₑₐₛ−DK_{ATM}]/[DK_{M}−DK_{ATM}]

respectively

H=[DKₘₑₐₛ−1]/[DK_{M}−1]*100%

In such case, DKₘₑₐₛ characterizes the relative dielectric constant measured with the sensor, DK_{ATM} the relative dielectric constant of the gas phase in the region above the surface of the medium, DK_{M} the relative dielectric constant of the medium, h the ascertained height of the fill level and H the maximum height of the fill level in the container.

In an advantageous further development of the apparatus of the invention, it is provided that the relative dielectric constant of the medium is predetermined. This is possible in many applications without problem, since the composition of the medium is well known and constant. Alternatively, an option is to provide a first reference sensor. This is preferably embodied analogously to a sensor of the invention for fill level measurement. The first reference sensor is at least temporarily so arranged that it interacts with the medium located in the container over the entire longitudinal extension of the electrode. The frequency detector, which is associated with the electrode of the sensor (this solution is advantageous for reasons of cost), or also a separate frequency detector, measures the frequency of the first reference sensor. The evaluation unit determines, based on the relative dielectric constant measured by the sensor and the predetermined or ascertained from the first reference sensor, relative dielectric constant of the medium, the fill level or the predetermined limit-level of the medium in the container. In this connection it is noted again that the solution of the invention reacts also to the magnetic property of the medium.

In an advantageous embodiment of the apparatus of the invention, it is provided that the relative dielectric constant of the medium residing in the gas phase is predetermined. Since in many cases the gas phase is air, the specification is simple. Alternatively, a second reference sensor is provided, which corresponds as regards its construction and its function preferably to the sensor or the first reference sensor. The second reference sensor is oriented essentially perpendicular to the electrode of the sensor and is arranged in a region of the container, in which the influencing of the electromagnetic waves coupled onto the electrode of the second reference sensor by the medium in the gas phase is at least at times constant. In each case, the second reference sensor must be so arranged that the influence of the medium on the measured values of the second reference sensor is excluded. The evaluation unit determines, respectively monitors, based on the predetermined or ascertained relative dielectric constants, the fill level or the predetermined limit-level of the medium in the container.

A preferred solution involves detecting a dividing layer occurring in a container and to determine the thickness of the dividing layer. In this case, there are located in the container besides the medium, whose fill level is to be monitored, and the medium in the gas phase, an additional medium, which is located in the dividing layer. Typical examples are an oil containing substance on a water surface, or a deposit on the floor of the container. In this regard, a third reference sensor is provided, which likewise again rests on the same measuring principle as the earlier described sensors. However, the longitudinal extension of the third reference sensor is different from the longitudinal extension of the sensor. The third reference sensor is oriented essentially parallel to the sensor. The longitudinal extension of the third reference sensor is so selected that the upper end region always lies above the maximum height of the dividing layer. The end region of the sensor facing the floor of the container and the end region of the third reference sensor facing the floor of the container are located at least approximately at the same height. The evaluation unit ascertains based on the relative dielectric constants besides the fill level of the medium in the container also the thickness of the dividing layer.

The evaluation by means of the evaluation unit occurs preferably according to the following formulas:

h=[[L+L/G−2(1+DKₘₑₐₛ+DK₃)]/[L/G−DKₘₑₐₛ−DK₃−1]−DK₃]/[DK_{M}−1]*100%

t=[L+L/G−2(1+DKₘₑₐₛ+DK₃)]/[L/G−DKₘₑₐₛ−DK₃−1]*100%

In such case:
DKₘₑₐₛ characterizes the relative dielectric constant measured with the sensor,
DK₃ the relative dielectric constant measured with the third reference sensor,
L the longitudinal extension of the third reference sensor,
G the longitudinal extension of the sensor, and
T the thickness of the dividing layer.

In an advantageous further development of the apparatus of the invention, all sensors have a defined longitudinal extension. For the case, in which the maximum fill level of the medium in the container amounts to a multiple of the longitudinal extension of the electrode, respectively of the sensor, a number of sensors are arranged in series one after the other distributed over the fill level on or in the container.

Especially advantageous in this connection is when the sensors are present with equal longitudinal extension as a tape product, respectively as yard goods. Preferably then provided between the individual sensors are predetermined breaking points, so that a length of the right number of sensors can be broken off for the maximum fill level to be measured or monitored for the medium in the container.

The invention will now be explained in greater detail based on the appended drawing, the figures of which show as follows:

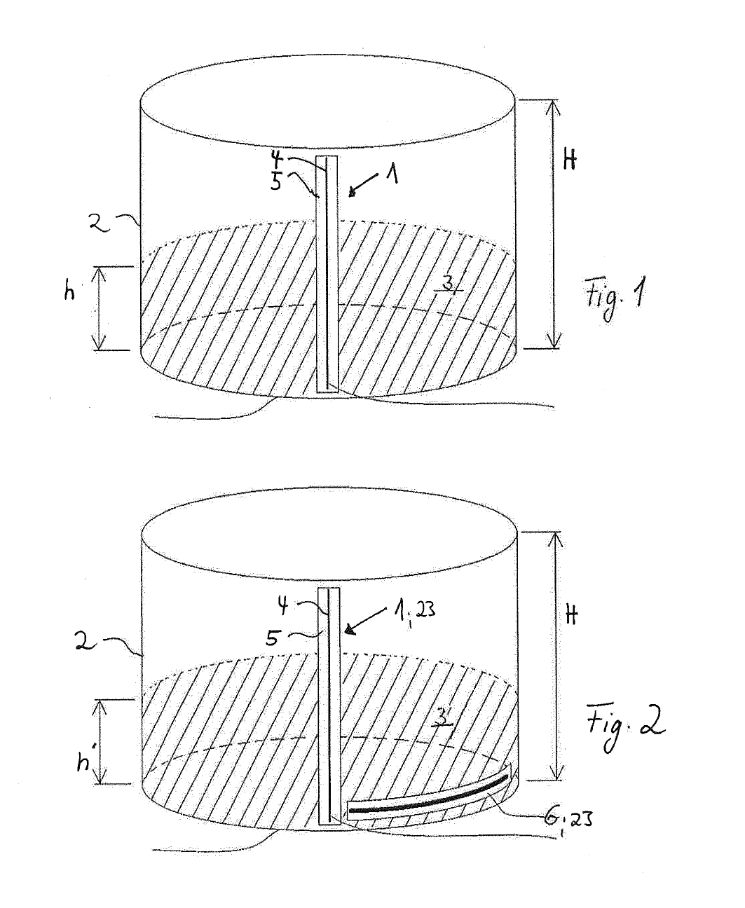

FIG. 1 a schematic representation of a first embodiment of the measuring arrangement of the invention for fill level measurement in a container,

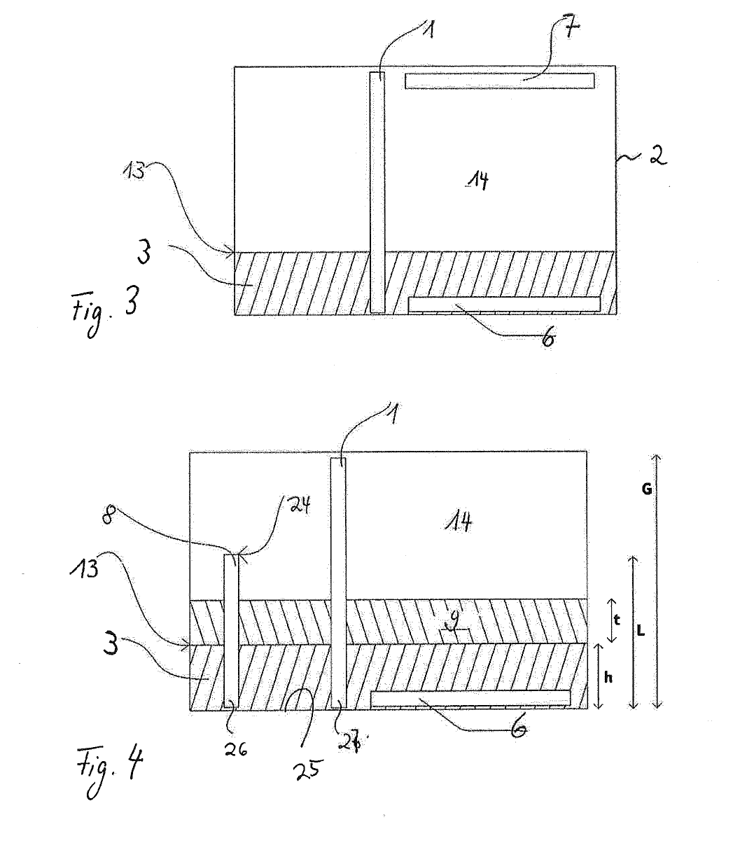

FIG. 2 a schematic representation of a second embodiment of the measuring arrangement of the invention for fill level measurement in a container,

FIG. 3 a schematic representation of a third embodiment of the measuring arrangement of the invention for fill level measurement in a container,

FIG. 4 a schematic representation of a fourth embodiment of the measuring arrangement of the invention for fill level measurement in a container,

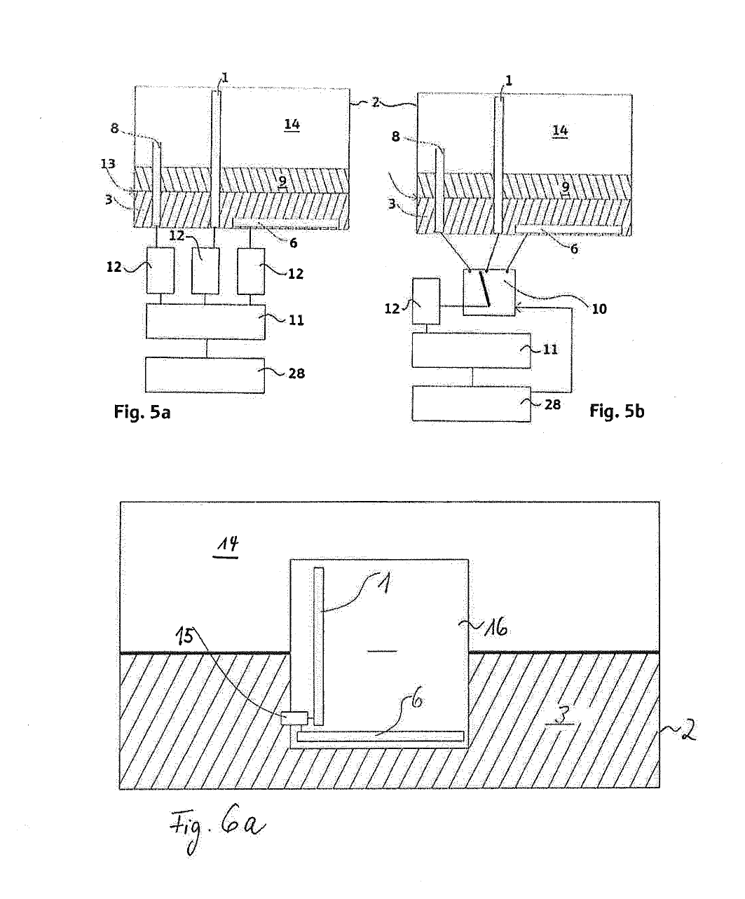

FIG. 5a the measuring arrangement shown in FIG. 4 with sensor electronics and evaluating electronics in a first embodiment,

FIG. 5b the measuring arrangement shown in FIG. 4 with sensor electronics and evaluating electronics in a second embodiment,

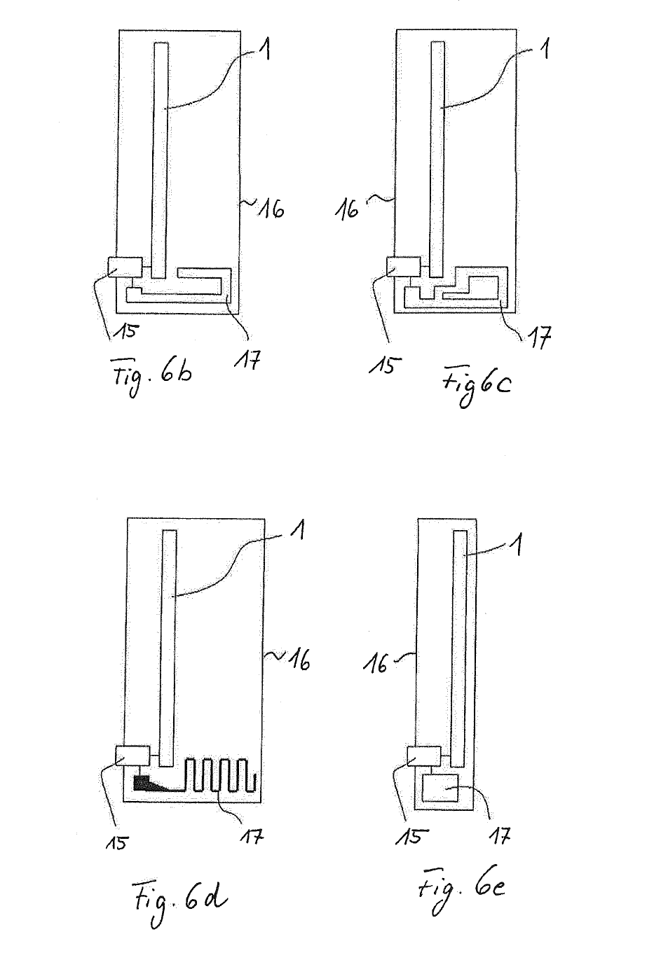

FIG. 6a-FIG. 6d different embodiments of a preferably used measuring arrangement of the invention,

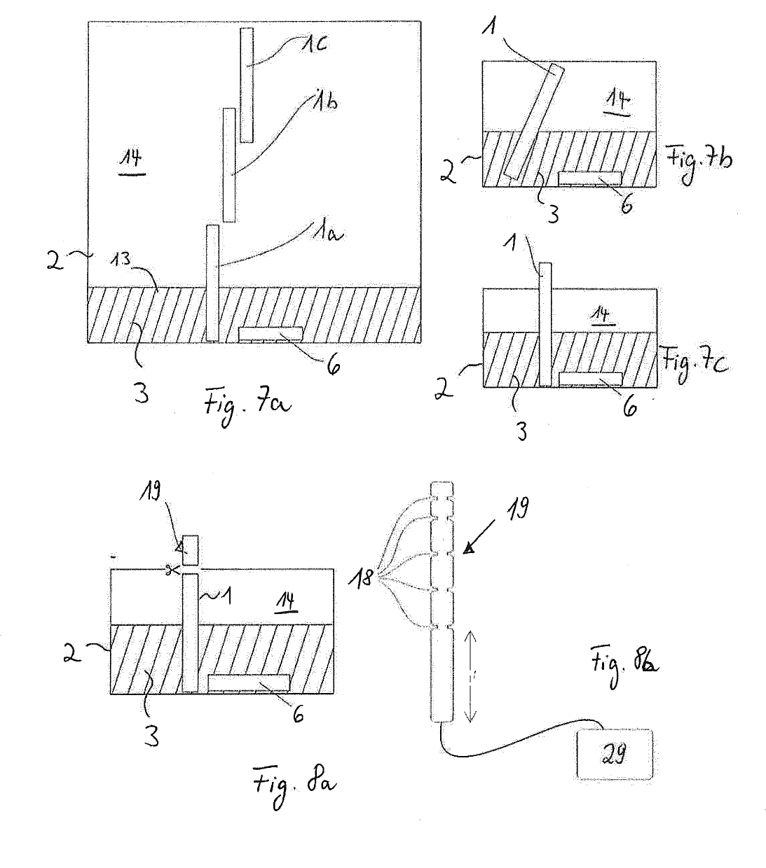

FIG. 7a-FIG. 7c different variants of the measuring arrangement of the invention,

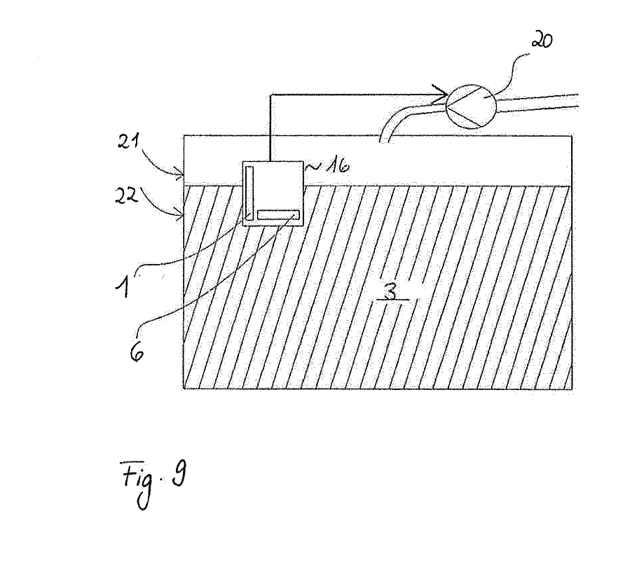

FIG. 8a, FIG. 8b other advantageous forms of embodiment of the apparatus of the invention, and

FIG. 9 a schematic representation of the solution of the invention used for controlling a pump.

Based on the schematic representation of a first arrangement of an apparatus of the invention reduced to its essential components for fill level measurement in a container 2, as shown in FIG. 1, the measuring principle of the solution of the invention will now be explained in greater detail. Container 2 is partially filled with a medium 3. The sensor 1 is placed externally on the container 2 and extends essentially parallel to the longitudinal axis of the container 2. The fill level h of the medium 3 in the container 2 can be expressed as an absolute value or as a percentage of the maximum fill level H possible in the container 2.

According to the invention, the concept is utilized that a microwave resonator 1 with a simple elongated electrode 4 positioned on a container outputs the linear average value of the relative dielectric constant of the adjoining media (3, 14) in the form of a frequency. The sensor of the invention 1 forms the average value of the adjoining media such that, for example, a medium 3 with a relative dielectric constant DK_{M} of 4 adjoining 25% of the sensor 1 and a medium 14 with a relative dielectric constant DK_{ATM} of 1 (air) adjoining 75% of the sensor 1 yields a measured dielectric constant DKₘₑₐₛ of

DKₘₑₐₛ=0.25*4+0.75*1=1.75,

respectively the frequency associated with the relative dielectric constant DKₘₑₐₛ of 1.75 results. The arrangement shown in FIG. 1 can be used, when the dielectric constant DK_{M} of the medium 3 and the dielectric constant DK_{ATM} of the gas phase 14 are known. In many applications in the foods, pharmaceuticals and chemicals industries, such is the case.

If the composition of the medium 3 changes during a monitoring process or the composition of the medium 3 is just not known, then the solution shown in FIG. 2 can be used. Besides the sensor 1, i.e. the actual fill-level sensor, a reference sensor 6 is provided, which is so arranged on/in the container 2 that it at least temporarily interacts over its entire longitudinal extension with the medium 3 located in the container 2. Since the frequency of the oscillatable system in interaction with the medium 3 assumes a value, which permits a unique association with the dielectric constant DK_{M} of the medium 3, the dielectric constant DK_{M} of the medium 3 can be determined via the reference sensor 6.

The formula for determining the fill level h of the medium 3 in the container 2 then becomes:

h*DK_{M}+(1−h)*DK_{ATM}=DKₘₑₐₛ (1)

There results from this:

h=[DKₘₑₐₛ−DK_{ATM}]/[DK_{M}−DK_{ATM}] (2)

In the simple case, in which the gas in the gas space 14 is air, the dielectric constant DK_{ATM}=1. The equation can then be rewritten as follows:

h=[DKₘₑₐₛ−1]/[DK_{M}−1] (3)

respectively normalized on the maximum fill level H in the container 2

H=[DKₘₑₐₛ−1]/[DK_{M}−1]*100% (4).

FIG. 3 shows a preferred measuring arrangement, when the dielectric constant DK_{ATM} of the medium in the gas phase 14 fluctuates or is unknown. Besides the sensor 1 and the first reference sensor 6, then a second reference sensor 7 is provided, which is so arranged that it at least at times interacts only with the gas phase 14. Based on the frequency which arises, then also here the dielectric constant DK_{ATM} of the gas phase 14 can be unequivocally determined. The fill level h, respectively H, can then be calculated via one of the above mentioned formulas.

A measuring arrangement especially suited for fill level measurement in the presence of a dividing layer 9 is shown in FIG. 4. The third reference sensor 8 is preferably embodied analogously to the sensor 1 or the first reference sensor 6 or the second reference sensor 7. The longitudinal extension L of the active part of the third reference sensor 8 differs from the longitudinal extension G of the active part of the sensor 1. Especially, the longitudinal extension L of the third reference sensor 8 is so selected that the upper end region 24 always lies above the maximum height of the dividing layer 9 in the container 2. The third reference sensor 8 is essentially parallel to the sensor 1—in the illustrated case, the two are parallel to the longitudinal axis of the container 2. The end region 27 of the sensor 1 facing the floor 25 of the container 3 and the end region 26 of the third reference sensor 8 facing the floor 25 of the container 3 lie at least approximately the same height. The sensor—and evaluating electronics (not shown in FIG. 4) ascertains based on the measured and/or predetermined relative dielectric constants DK_{M}, DK_{ATM}, DKₘₑₐₛ the thickness t of the dividing layer 9. In the following formulas, DK_{T} is the dielectric constant of the medium in the dividing layer 9 and DK₃ the dielectric constant measured by the third reference sensor 8.

h*DK_{M}+(1−h−t)DK_{ATM}+t*DK_{T}=DKₘₑₐₛ (5)

as well as

h*DK_{M}+(L−h−t)DK_{ATM}+DK_{T}=DK₃ (6)

The fill level (H) can then be calculated according to the following formula:

H=[[L+L/G−2(1+DKₘₑₐₛ+DK₃)]/[L/G−DKₘₑₐₛ−DK₃−1]−DK₃]/[DK_{M}−1]100% (7)
with ∈ₕ=∈₀*DK_{M}

For the thickness t, respectively T, of the dividing layer 9, it follows that:

T=[L+L/G−2(1+DKₘₑₐₛ+DK₃)]/[L/G−DKₘₑₐₛ−DK₃−1]*100% (8)
with ∈_{T}=∈₀*(1+DKₘₑₐₛ+DK₃−L/G)

In the described case, the dividing layer 9 lies above the first reference sensor 6 and below the upper end region 24 of the third reference sensor 8. If the lower end regions 25, 26 of the sensor 1 and of the third reference sensor 8 lie not at one height, then the dielectric constant DK_{ATM} of the gas phase 14 must also be taken into consideration. For this, such as already discussed above, a second reference sensor 7 can be applied. Known from DE 10 2012 104 075 A1 of May 9, 2012, is a sensor, which is so sensitive that it can be applied for determining the dielectric constant of the dividing layer 9 (here an indirect measuring of the foam thickness and density). The corresponding content of DE 10 2012 104 075 A1 (not pre-published) is to be added to this disclosure of the present invention.

In principle, it is, of course, possible in connection with the invention not to measure all dielectric constants of the medium and the gas phase, in given cases, also the dividing layer, but, instead, to input them in the form of known values into the evaluating electronics. Since the dielectric constant DK_{M} of a medium 3, especially water, however, also other known media, is temperature dependent, the accuracy of measurement can be improved by providing at least one temperature sensor (not shown). In this way, the temperature effect can be compensated by calculation.

Shown in FIGS. 5a and 5b is the measuring arrangement shown in FIG. 4 with frequency detector 11, sensor electronics 12 and evaluating electronics, respectively evaluation unit, 28 in two different embodiments. In FIG. 5a, a sensor electronics 12 is associated with each sensor, respectively each reference sensor 1, 6, 8. In FIG. 5a, thus, three oscillatable systems are present. These are composed of the first oscillatable system 1, 12, the second oscillatable system 6, 12 and the third oscillateable system 7, 12. This solution is quite possible, since the component costs for the required electronics are relatively small. For the purpose of energy saving, the individual sensors 1, respectively reference sensors 6, 7, 8, are operated alternately by the evaluating electronics 28.

In the case of the embodiment shown in FIG. 5b, a number of sensors 1, 6, 8 are connected via a switch 10 with only one sensor electronics 12 and a frequency detector 11. The switching of the switch 10 is controlled by the evaluating electronics/evaluation unit 28. In the case of this embodiment, only one oscillatable system is present. As a function of the position of the switch 10, the oscillatable system is composed of one of the three following configurations: The sensor 1, the switch 10 and the sensor electronics 12, or the first reference sensor 6, the switch 10 and the sensor electronics 12, or the third reference sensor 8, the switch 10 and the sensor electronics 12.

FIGS. 6a-6d show different embodiments of a preferably used measuring arrangement of the invention in the form of adhesive arrangements 16, respectively adhesive labels. Each adhesive label 16 is provided with at least two sensors 1, 6 and at least one plug connector 15. The measuring arrangements can be embodied very compactly. If a correspondingly high operating frequency is selected, the illustrated sensors can also be executed in MEMS technology.

The shown adhesive arrangements 16 can, moreover, be integrated without problem into e.g. a single use, plastic bag (medical technology) or into a mini-biolaboratory container. The measuring can occur also here through a non-conductive and non-magnetic wall.

Shown in FIGS. 7a-7c are other variants of the measuring arrangement of the invention. Each of the sensors 1 shown in FIG. 7a has a defined longitudinal extension G. For the case, in which the maximum fill level H of the medium 3 in the container 2 amounts to a multiple of the longitudinal extensions G of the electrode 4, respectively of the sensor 1, a number of sensors 1 are arranged in series distributed over the maximum fill level H on or in the container 2.

Especially advantageous in connection with the solution of the invention is when the sensors are provided in the form of tape 19, and it is possible by suitable shortening of the sensor 1, 8 to match the desired or required maximum fill level H of the container 2. For this, however, a calibrating of the sensor 1, 8 must occur. In order to perform a correct measuring, the particular length of the sensor 1, 6, 7, 8 must be known to the evaluation unit 28, 29, and/or, for the purpose of adjustment, at least the current fill level at the point in time of the measuring must be known. In order to assure a higher accuracy of measurement, the sensor 1, 8 should be calibrated at two measurement points, e.g. the measurement points “minimum fill level” and “maximum fill level”. Furthermore, a learning phase can be provided, in which the outer band limits of a sensor are ascertained. The fill level is then uniformly, or according to container form, a value of 0% to 100% in the measured range. During this learning phase, it is necessary to visit the minimum and maximum fill levels to be measured at least once. Reference is made in this connection to the above cited, non-pre-published, German patent application of the applicant.

A two-point calibration means additionally that the first reference sensor 6 for measuring the dielectric constant DK_{M} of the medium 3 can be omitted (compare FIG. 1). As already indicated above, it is alternatively possible that the operator provides the dielectric constant DK_{M} of the medium 3 to the evaluation unit 28. This requires, however, that the dielectric constant DK_{M} of the medium 3 in the context of the desired accuracy of measurement is constant during the measuring.

In practice, the length of a predetermined sensor 1 hardly ever agrees with the longitudinal extension of a container 2 or an arrangement, in the case of which the fill level should be determined or monitored. In the case of a larger container 2, it can be sufficient to measure the fill level h only in a certain limited range. A corresponding example of application is shown in FIG. 9. Of concern in the case of the shown arrangement is a gate circuit for setting the upper switch off point 21 and the lower switch on point 22 of a pump 20.

A particularly useful method is shown in FIG. 8b. The tape 19 includes repetitive, predetermined, breaking points 18, which are marked, for example, by printed lines. The operator selects the weak point 18 suitable for the installation for shortening to the desired sensor 1, 8 length and reports this to the evaluating electronics 29. The evaluating electronics 29 contains the frequency detector 11, the sensor electronics 12 and the evaluation unit. This solution is more convenient than the shortening shown in FIG. 8a by means of a cutting tool to the required length and the report concerning the respective length to the evaluation unit 28. Moreover, by shortening in predetermined subsections, it can be prevented that the shortening is too much and the sensor 1 fails to function, because the required minimum length is not achieved. A shortening below the needed minimum length damages the sensor irreversibly. The reason for this is as follows: The frequency detector 11 within the evaluation unit 29 has a lower detection threshold, upon whose exceeding changes of a connected sensor 19 are detected. In order to guarantee a secure measuring above this detection threshold, a minimum length of the sensor 19 is provided, which assures that a sufficient interaction between the microwaves and the electrical or magnetic properties of the adjoining medium, respectively the adjoining media, is assured. This detection threshold depends on the circuit complexity of the sensor electronics 12 and the frequency detector 11.

The measuring arrangement can also be formed in such a manner that two sensors 1 of different longitudinal extensions are provided, which extend, or are temporarily immersed from above, into the container 2. From this, the immersion depth in the medium 3 can be calculated and the fill level h of the medium 3 in the container deduced. The dielectric constant of the medium 3 can be predetermined or be registered by an additional sensor.

### LIST OF REFERENCE CHARACTERS

1 sensor
2 container
3 medium
4 electrode
5 insulating material
6 first reference sensor/sensor for determining DK_{M}
7 second reference sensor/sensor for determining DK_{ATM}
8 third reference sensor/sensor for determining DK₃
9 dividing layer
10 switch
11 frequency detector
12 sensor electronics
13 interface
14 gas phase
15 plug connectors
16 adhesive arrangement
17 compact reference sensor
18 desired break location
19 tape
20 pump
21 upper switch off limit
22 lower switch on limit
23 measuring cell
24 upper end region
25 floor of the container
26 lower end region of the third reference sensor
27 lower end region of the sensor
28 evaluating electronics/evaluation unit
29 frequency detector/sensor—and evaluating electronics/evaluation unit

1-11. (canceled)

12. The apparatus for determining or monitoring fill level or a predetermined limit level of a medium in a container, comprising:
a self excited system, comprising:
an oscillation producing unit for producing electromagnetic waves within a predetermined frequency band;
at least one sensor having an electrode, said at least one sensor is arranged at a predetermined angle to the longitudinal axis of the container, said electrode is supplied with the electromagnetic waves, and said at least one sensor is arranged relative to the medium in such a manner that the phase of the electromagnetic waves reflected at the interface of the medium changes under the influence of the medium;
a feedback loop, which feeds the electromagnetic waves back to said at least one sensor, whereby the frequency of the self excited system is determined;
a frequency detector, which registers the frequency of the electromagnetic waves; and
an evaluation unit, which based on the registered frequency ascertains the relative dielectric constant and/or the permeability of the medium dependent on the respective fill level and based on the ascertained relative dielectric constant or the permeability of the medium determines the fill level or the reaching of the predetermined limit level of the medium in the container.

13. The apparatus as claimed in claim 12, wherein:
said at least one the sensor is composed of an electrode, which is arranged on an insulating material; and
said electrode and said insulating material form a measuring cell.

14. The apparatus as claimed in claim 12, wherein:
said at least one sensor or said measuring cell is arranged with respect to one of:
on the inner wall of the container, on the outer wall of the container and in the medium.

15. The apparatus as claimed in claim 12, wherein:
said evaluation unit calculates the fill level absolutely or relative to the maximum height of the fill level of the container according to the following formulas:
h=[DKₘₑₐₛ−DK_{ATM}][DK_{M}−DK_{ATM}],
respectively
H=[DKₘₑₐₛ−1]/[DK_{M}−1]*100%,
wherein DKₘₑₐₛ is the relative dielectric constant measured with said at least one sensor, DK_{ATM} the relative dielectric constant of the gas phase in the region above the surface of the medium and DK_{M} the relative dielectric constant of the medium.

16. The apparatus as claimed in claim 12, wherein:
the relative dielectric constant of the medium is predetermined, or wherein a first reference sensor is provided, which is embodied corresponding to said at least one sensor, said first reference sensor is at least temporarily so arranged that it interacts with the medium over the entire longitudinal extension of said electrode;
said frequency detector measures the frequency of said first reference sensor; and
said evaluation unit determines based on the relative dielectric constant measured by said at least one sensor and the predetermined or ascertained from said first reference sensor, relative dielectric constant of the medium, the fill level or the predetermined limit-level of the medium in the container.

17. The apparatus as claimed in claim 12, wherein:
the relative dielectric constant the medium residing in the gas phase is predetermined, or a second reference sensor is provided, which is embodied corresponding to said at least one sensor and/or said first reference sensor;
said electrode of said second reference sensor is oriented essentially perpendicular to said electrode of said at least one sensor;
said second reference sensor is arranged in a region of the container, in which the influencing of the electromagnetic waves coupled onto said electrode of said second reference sensor by the medium located in the gas phase is at least at times constant; and
said evaluation unit determined or monitors, based on the predetermined or ascertained relative dielectric constants, the fill level or the predetermined limit-level of the medium in the container.

18. The apparatus as claimed in claim 12, wherein:
located in the container besides the medium in the gas phase and the medium, whose fill level is to be monitored or determined, is a second medium arranged in a dividing layer;
a third reference sensor is provided, which is embodied corresponding to said at least one sensor or said first reference sensor or said second reference sensor;
the longitudinal extension of said third reference sensor differs from the longitudinal extension of said at least one sensor;
the longitudinal extension of said third reference sensor is so selected that the upper end region always lies above the maximum height of said dividing layer;
said third reference sensor is oriented essentially parallel to said at least one sensor;
the end region of said at least one sensor facing the floor of the container and the end region of said third reference sensor facing the floor of the container lie at least approximately at the same height; and
said evaluation unit ascertains based on the ascertained relative dielectric constants the thickness of the dividing layer.

19. The apparatus as claimed in claim 18, wherein:
said evaluation unit calculates the fill level (h) of the medium in the container according to the following formula:
h=[[L+L/G−2(1+DKₘₑₐₛ+DK₃)]/[L/G−DKₘₑₐₛ−DK₃−1]−DK₃]/[DK_{M}−1]*100%
and the thickness (t) of said dividing layer according to the following formula:
t=[L+L/G−2(1+DKₘₑₐₛ+DK₃)]/[L/G−DKₘₑₐₛ−DK₃−1]*100%
wherein: DKₘₑₐₛ is the relative dielectric constant measured with said at least one sensor, DK₃ the relative dielectric constant measured with said third reference sensor, L the longitudinal extension of said third reference sensor, and G the longitudinal extension of said at least one sensor.

20. The apparatus as claimed in claim 12, wherein:
said at least one sensor has a defined longitudinal extension; and
for the case, in which the maximum fill level of the medium in the container amounts to a multiple of the longitudinal extension of said electrode, respectively of said sensor, a number of sensors are arranged in series one after the other distributed over the maximum fill level on or in the container.

21. The apparatus as claimed in claim 12, wherein:
a plurality of sensors are present with equal longitudinal extension as a tape product;
provided between the individual sensors are predetermined breaking points, so that a length of a right number of sensors can be broken off for the maximum fill level of the medium to be measured or monitored in the container.

22. The apparatus as claimed in claim 12, wherein:
said frequency detector and said evaluation unit are associated with a plurality of sensors and/or reference sensors.
